(19) United States
(12) Patent Application Publication
(10) Pub. No.: US 2025/0179593 A1
(43) Pub. Date: Jun. 5, 2025

(54) BLAST FURNACE OPERATION METHOD

(71) Applicant: NIPPON STEEL CORPORATION, Tokyo (JP)

(72) Inventor: Masaaki TOKUNAGA, Tokyo (JP)

(73) Assignee: NIPPON STEEL CORPORATION, Tokyo (JP)

(21) Appl. No.: 18/836,896

(22) PCT Filed: Feb. 7, 2023
(86) PCT No.: PCT/JP2023/004031

§ 371 Date: Aug. 8, 2024

(30) Foreign Application Priority Data
Feb. 8, 2022 (JP) 2022-017709
Mar. 24, 2022 (JP) 2022-047843

(51) Int. Cl. C21B 7/00; C21B 7/16

(52) U.S. Cl. CPC C21B 7/002; C21B 7/16; C21B 2100/26; C21B 2100/282

(57) ABSTRACT

When CO₂ is removed from a blast furnace gas containing unused CO gas and CO gas after removing CO₂ is again injected into a blast furnace, nitrogen accumulates in the blast furnace. O₂ is thus injected instead of blast. This causes the absence of nitrogen in front of a tuyere, so that a volume of gas generated in front of the tuyere is insufficient and a temperature in front of the tuyere rises, resulting in a difficulty in the blast furnace operation. N₂ gas or CO₂ gas is thus injected together with the CO gas injected through the tuyere, and circulated.

### TECHNICAL FIELD

The present invention relates to a blast furnace operation method.

### BACKGROUND ART

In order to restrain global warming caused by the increase in CO₂ discharge, there is a strong demand for the reduction in CO₂ discharge. The steel industry generates a large amount of CO₂, and faces a serious problem of reducing the CO₂ discharge. The main source of CO₂ discharge from steel plants is blast furnaces. It is thus requested to reduce the CO₂ discharge from the blast furnaces.

There is a technique to inject a blast furnace gas into a blast furnace for the purpose of reducing the CO₂ discharge from the blast furnace. Patent Literature 1 discloses a blast furnace operation method, in which CO₂ is separated and removed from at least a part of a blast furnace gas discharged from a blast furnace top, the blast furnace gas is heated to raise the temperature thereof and then is injected through a gas inlet A provided at a blast furnace shaft, and a preheat gas is injected into the furnace through a gas inlet B provided above the gas inlet A.

Patent Literature 2 discloses a blast furnace operation method for addressing problems in an oxygen blast furnace, the problems including (1) a temperature Tf in front of the tuyere (hereinafter also referred to as “tuyere-front temperature Tf”) becomes excessively high; and (2) a heat flow ratio becomes too large, reducing heat transfer to the charge. With regard to (1), CO₂, H₂O, or the like is injected through the tuyere to keep the tuyere-front temperature Tf in a range from 2,000 degrees C. to 2,600 degrees C. With regard (2), a preheat gas is injected through an inlet at a middle section of the shaft.

Patent Literature 3 discloses a blast furnace operation method including steps of: generating a steam reforming gas using steam and a thermally decomposed gas generated by thermal decomposition of waste plastics; generating a recycled methane gas using a blast furnace gas and hydrogen gas generated from the steam reforming gas; and injecting a blast gas and a reducing material through a tuyere of a blast furnace into the blast furnace, where the blast gas is oxygen gas and at least a part of the reducing material is the recycled methane gas.

Non-Patent Literature 1 discloses a study on permeation of a furnace top gas injected into the blast furnace.

### CITATION LIST

### Patent Literature(s)

Patent Literature 1: JP 2018-70952 A
Patent Literature 2: JP S60-159104 A
Patent Literature 3: JP 2021-152212 A

### Non-Patent Literature(s)

“On the Top Gas Recycled Reforming Process and the Injected Gas Distribution” by Nishio et al., Tetsu-to-Hagane, Vol. 59 (1973) No. 12

### SUMMARY OF THE INVENTION

Problem(s) to be Solved by the Invention

Various ideas have been proposed to inject a blast furnace gas into a blast furnace to reduce the CO₂ discharge. In Patent Literature 1 and Non-Patent Literature 1, the blast furnace gas is injected into the blast furnace from a lower part of a shaft. The blast furnace gas, however, does not sufficiently permeate into an inside of the furnace. The blast furnace gas is preferably injected through a tuyere of the blast furnace (hereinafter also referred to as “blast furnace tuyere” or simply “tuyere”) in injecting the blast furnace gas into the blast furnace.

Further, Patent Literature 2 describes the problems associated with an oxygen blast furnace in which the tuyere-front temperature Tf becomes excessively high and the heat flow ratio becomes excessively large due to the decrease in gas volume in front of the tuyere to make heat transfer to the charge insufficient. It is necessary to inject the preheat gas at the shaft to compensate for the heat flow ratio. Patent Literature 3 discloses that CO₂ and CO gases in the blast furnace gas are transformed into CH₄ by hydrogen and the CH₄ is injected through a blast furnace tuyere. Injecting a large amount of CH₄ decreases the temperature in front of the tuyere. In view of the above, injecting oxygen in place of hot blast (air) allows a large amount of CH₄ to be injected without lowering the temperature in front of the tuyere. In other words, the blast furnace gas can be injected through the blast furnace tuyere. In this case, instead of using commercially available hydrogen, hydrogen is synthesized from waste plastics.

It should be noted that, when a reducing gas is injected through the blast furnace tuyere, attention should be paid to a change in gas volume in a raceway in front of the tuyere (hereinafter also referred to as “tuyere-front raceway”) as well as prevention of a decrease in the temperature in front of the tuyere. This is because the change in the gas volume in the tuyere-front raceway results in a change in the gas volume inside the blast furnace, which changes the heat flow ratio (i.e. a ratio of a heat capacity of a solid to a heat capacity of a gas). There is also a problem of the production cost of hydrogen produced from the waste plastics.

An object of the invention is to prevent, in a blast furnace operation involving injection of oxygen and a blast furnace gas (CO gas generated by removing CO₂ from a furnace top gas) through a tuyere, an increase in a temperature Tf in a raceway in front of the tuyere (hereinafter also referred to as “tuyere-front raceway temperature Tf”) and a decrease in gas volume at a lower part of the furnace, thereby reducing CO₂ discharged from the blast furnace under operation conditions similar to those in a normal operation.

### Means for Solving the Problems

The gist of the invention is as follows.
(1) A blast furnace operation method including: injecting O₂ gas through a tuyere of a blast furnace; separating and removing CO₂ from a blast furnace gas discharged from a furnace top of the blast furnace; and injecting all of CO gas after removing CO₂ through the tuyere of the blast furnace, in which all of N₂ gas, which is injected through the tuyere of the blast furnace and discharged from the furnace top of the blast furnace together with the CO gas after removing CO₂, is circulated within the blast furnace.
(2) A blast furnace operation method including: injecting O₂ gas through a tuyere of a blast furnace; separating and removing CO₂ from a blast furnace gas discharged from a furnace top of the blast furnace; and injecting a part of CO gas after removing CO₂ through the tuyere of the blast furnace, in which N₂ gas, which is injected through the tuyere of the blast furnace and discharged through the furnace top of the blast furnace together with the part of the CO gas after removing CO₂, is circulated within the blast furnace.
(3) The blast furnace operation method according to (1) or (2), in which an H₂ gas is injected through the tuyere of the blast furnace and the CO gas after removing CO₂ contains the H₂ gas.
(4) A blast furnace operation method including: injecting O₂ gas through a tuyere of a blast furnace; separating and removing CO₂ from a part of a blast furnace gas discharged from a furnace top of the blast furnace to produce a CO gas; and injecting, through the tuyere of the blast furnace, all of the CO gas after removing CO₂ together with a rest of the blast furnace gas not separating and removing CO₂ from the blast furnace gas discharged from the furnace top of the blast furnace.
(5) A blast furnace operation method including: injecting O₂ gas through a tuyere of a blast furnace; separating and removing CO₂ from a part of a blast furnace gas discharged from a furnace top of the blast furnace to produce a CO gas; and injecting, through the tuyere of the blast furnace, a part of the CO gas after removing CO₂ together with a rest of the blast furnace gas not separating and removing CO₂ from the blast furnace gas discharged from the furnace top of the blast furnace.
(6) The blast furnace operation method according to (4) or (5), in which an H₂ gas is injected through the tuyere of the blast furnace and the CO gas after removing CO₂ contains the H₂ gas.

In the following, “injecting N₂ gas through the tuyere of the blast furnace together with CO₂-removed CO gas (i.e. CO gas after removing CO₂ from the blast furnace gas) and circulating the N₂ gas discharged from the furnace top within the blast furnace” will be occasionally referred to as “N₂ gas circulation”. Further, “injecting, through the tuyere of the blast furnace, all of the CO₂-removed CO gas together with the rest of the blast furnace gas not separating and removing CO₂ from the blast furnace gas” will be occasionally referred to as “CO₂ gas circulation”.

The invention relates to a blast furnace operation method in which all of the CO gas obtained by separating and removing CO₂ from the blast furnace gas is injected through the blast furnace tuyere. CO₂ can be removed from the furnace top gas using CCS (CO₂ capture and storage) technique. However, the blast furnace gas still contains a large amount of N₂ only by removing CO₂. Thus, when all of such a blast furnace gas is injected through the tuyere, N₂ accumulates in the blast furnace, making it difficult to continue the blast furnace operation. In order to prevent the N₂ accumulation, it is necessary to inject oxygen in place of air through the tuyere. However, when oxygen is solely injected, the gas volume generated in the tuyere-front raceway decreases due to the absence of N₂, which changes the heat flow ratio and increases the tuyere-front raceway temperature Tf, thereby making it difficult to perform the blast furnace operation.

The invention is made to solve the above problems.
(1) In a blast furnace operation in which O₂ gas and all of the CO₂-removed CO gas are injected through the blast furnace tuyere, the tuyere-front raceway temperature Tf becomes too high to perform the blast furnace operation. By employing the N₂ gas circulation or CO₂ gas circulation together with the CO gas, the tuyere-front raceway temperature Tf can be set at the same level as that in the normal operation.
(2) When the amount of gas generated in the tuyere-front raceway of the blast furnace greatly changes from that in the normal operation of existing large blast furnaces, it is difficult to perform the blast furnace operation. By employing the N₂ gas circulation or CO₂ gas circulation, the amount of gas generated in the tuyere-front raceway can be set substantially at the same level as that in the normal operation.
(3) N₂ gas circulation or CO₂ gas circulation according to the invention is capable of maintaining the heat flow ratio and the tuyere-front raceway temperature Tf that are the substantially the same as those of a base operation (normal operation), making it possible to reduce the discharge of CO₂ gas with existing blast furnace operation techniques.

### BRIEF DESCRIPTION OF DRAWINGS

FIG. 1 is a conceptual diagram illustrating a blast furnace operation method using N₂ gas circulation.

FIG. 2 illustrates a base operation.

FIG. 3 illustrates a flow of a blast furnace operation method including injection of CO₂-removed CO gas through a blast furnace tuyere without N₂ gas circulation.

FIG. 4 illustrates a flow of a blast furnace operation method using N₂ gas circulation.

FIG. 5 illustrates that CO gas injected through the blast furnace tuyere is 1 mol when 1 mol of carbon is charged into a blast furnace.

FIG. 6 illustrates that a part of the CO₂-removed CO gas or a part of H₂ gas is injected through the blast furnace tuyere.

FIG. 7 illustrates CO₂ gas circulation where all of the CO₂-removed CO gas and a part of a blast furnace gas discharged from a furnace top are injected through the blast furnace tuyere.

FIG. 8 illustrates CO₂ gas circulation where a part of the CO₂-removed CO gas and a part of the blast furnace gas discharged from the furnace top are injected through the blast furnace tuyere.

### DESCRIPTION OF EMBODIMENT(S)

There is a demand for the reduction in discharge of carbon dioxide to prevent global warming. In the steel industry, a blast furnace 1 is equipment that mainly discharges carbon dioxide. N₂ gas circulation or CO₂ gas circulation according to the invention is capable of maintaining a heat flow ratio and a raceway temperature in front of a tuyere Tf (hereinafter also referred to as a tuyere-front raceway temperature Tf) that are the substantially the same as those of a base operation (normal operation), making it possible to reduce the discharge of CO₂ gas with existing blast furnace operation techniques.

### Base Operation

### Comparative 1 (Table 1)

First, a base operation will be described. The base operation refers to a blast furnace operation having been usually carried out since before the filing of the invention. Premises of the base operation are as follows.
(1-1) For easy understanding of the description, it is assumed that the blast furnace 1 is in all-coke operation, where a blast volume per unit time is 100 Nm³ (N₂: 79 Nm³, O2:21 Nm³) and a blast temperature is 1,000 degrees C.
(1-2) It is assumed that an indirect reduction rate and a direct reduction rate in the blast furnace are 70% and 30%, respectively.
(1-3) It is assumed that a gas utilization efficiency (ηCO) in the blast furnace is 50%.
(1-4) It is assumed that ore to be charged is totally composed of Fe₂O₃.
(1-5) Although a part of charged carbon enters into pig iron, such carbon is not directly involved in reactions in the blast furnace. The following description will thus be made on iron containing no carbon.

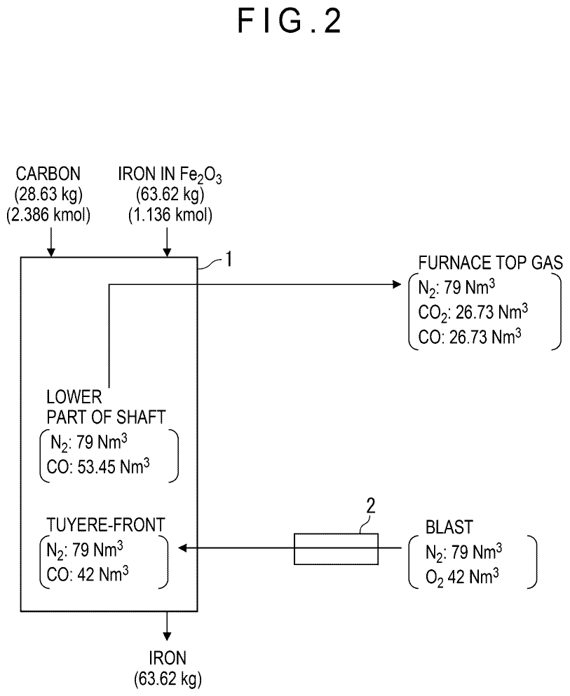

FIG. 2 illustrates an in-furnace status of the blast furnace 1 in the base operation.

The blast volume is 100 Nm³, in which N₂ accounts for 79 Nm³ and O₂ accounts for 21 Nm³. In a gas composition in a raceway in front of a tuyere, N₂ stays unreacted whereas O₂ is transformed into 42 Nm³ of CO by a reaction of C+O₂→2CO.

The composition in a lower part of the shaft is as follows. It is assumed that a part of charged carbon is transformed into X Nm³ of CO by a reaction of FeO+C→Fe+CO, which is a direct reduction. The X Nm³ of CO generated by direct reduction is combined with 42 Nm³ of CO in front of the tuyere to contribute to indirect reduction. Since the gas utilization efficiency is 50%, a half of CO generated in a lower part of the furnace contributes to the indirect reduction. The direct reduction rate is 30% as premised, establishing the following equation.

$$\frac{X}{0.5 \times ( 42 + X ) + X} = 0.3 \to X = 11.45 {Nm}^{3} \qquad [ Formula 1 ]$$

In the above, the numerator is an amount of oxygen consumed by the direct reduction. The denominator is a sum of the oxygen consumed by the direct reduction and the oxygen consumed by the indirect reduction, which is a half (gas utilization efficiency: 50%) of a sum of CO generated in front of the tuyere and CO (X) generated by the direct reduction. From this formula, X=11.45 is satisfied, and the volume of CO at the lower part of the shaft is 42+11.45=53.45 Nm³.

The composition of a furnace top gas is as follows. The utilization efficiency of a blast furnace gas (ηCO) is 50%. Accordingly, the 53.45 Nm³ of CO generated at the lower part of the shaft turns into 26.73 Nm³ of CO₂ and 26.73 Nm³ of CO in the furnace top gas.

All of the charged carbon turns into CO or CO₂ contained in the furnace top gas. Accordingly, the amount of charged carbon is 53.45/22.4=2.386 mol, which is 2.386×12=28.63 kg.

The yield of iron can be calculated based on an oxygen balance. Oxygen from the blast is 21 Nm³/22.4×32 kg=30 kg. Oxygen contained in the furnace top gas is 26.73 Nm³/22.4×16 kg+26.73 Nm³/22.4×32 kg=57.27 kg. Oxygen taken away from iron ore is 57.27−30=27.27 kg. Accordingly, the yield of iron is 27.27×112/48=63.62 kg. In the above, 112/48 is a ratio between iron and oxygen in Fe₂O₃ (56×2/16×3).

Assuming that carbon in pig iron is 4.5%, a yield of the pig iron is 63.62/0.955=66.62 kg.

Assuming that carbon in coke is 90%, the volume of charged coke is 28.63/0.9=31.81 kg. 28.63 is an amount of the charged carbon. As described above, all of the charged carbon turns into CO or CO₂ contained in the furnace top gas. Accordingly, the amount of charged carbon is 53.45/22.4=2.386 mol, which is 2.386×12=28.63 kg.

A ratio of coke is 31.81 kg/66.62 kg=477 kg/tpig.

### Heat Input During Base Operation

Next, a heat input during the base operation is calculated below.

In FIG. 2, the source of heat input to the blast furnace 1 is charged carbon and sensible heat of blast heated by a hot-blast stove 2. The charged carbon is reacted to be oxidized with oxygen in the blast furnace, turns into CO₂ and CO, and is discharged as the furnace top gas. Combustion heat of C is formation heat of CO₂ and CO. Thus, the heat input to the blast furnace 1 is a sum of the formation heat of CO₂ and CO in the furnace top gas and the sensible heat of blast.
(2-1) The amount of the heat input generated by the reaction of the charged carbon to CO₂ is, considering that a half (1.193 kmol) of the charged carbon (2.386 kmol) turns into CO₂ in FIG. 2, 1.193 kmol×393.5 kJ/mol×0.239 cal/J×10³=112.2×10³ kcal. As described in “Basic Chemistry” 21nd edition (Shokabo Co., Ltd.), p.132, a standard formation heat of gas in an oxidation process of C into CO₂ (C+O₂=CO₂) is ΔH=−393.5 kJ/mol.
(2-2) The amount of the heat input generated by reaction of the charged carbon to CO is, considering that a half (1.193 kmol) of the charged carbon (2.386 kmol) turns into CO in FIG. 2, 1.193 kmol×110.5 kJ/mol×0.239 cal/J×10³=31.51×10³ kcal. The formation heat of CO gas is ΔH=−110.5 kJ/mol.
(2-3) The temperature of blast is 1,000 degrees C. The sensible heat of blast, in which the N₂ component accounts for 26.37×10³ kcal and the O₂ component accounts for 7.41×10³ kcal, is 33.78×10³ kcal in total. The sensible heat of N₂ (26.37×10³ kcal) is calculated by (79 Nm³/22.4)×28 kg×0.267 cal/kg. The sensible heat of O₂ (7.41×10³ kcal) is calculated by (21 Nm³/22.4)×32 kg×0.247 cal/kg. Specific heats of N₂ and O₂ at 1,000 degrees C. are 0.267 cal/kg and 0.247 cal/kg, respectively.
(2-4) The heat input is 177.5×10³ kcal in total (breakdown: 112.2×10³ kcal+31.5×10³ kcal+33.78×10³ kcal).

As illustrated in FIG. 2, a heat amount of 177.5×10³ kcal is needed to produce 63.62 kg of iron. This heat includes a reduction heat of iron, heat transferred to pig iron and slag, heat diffused from a furnace body, and the like. The breakdown is reduction heat of iron (67.6%), sensible heat of hot metal or slag (17.2%), sensible heat of furnace top gas (6.2%), lost heat in furnace body, and the like (“Manufacture of Pig Iron/Steel” (Asakura Publishing Co., Ltd.), p.22).

### Tuyere-Front Raceway Temperature Tf During Base Operation

### Heat Input to Tuyere-Front Raceway

(3-1) Sensible heat of blast: 33.78×10³ kcal (see (2-3) above)
(3-2) Carbon combustion heat: 49.53×10³ kcal (1.875 kmol×110.5 kJ/mol×0.239 Cal/J)
(3-3) Heat capacity of carbon entering tuyere-front raceway: 20.25×10³ kcal Assuming that the tuyere-front raceway temperature is 2,400 degrees C., the temperature of carbon entering the tuyere-front raceway is 0.75 times as high as the tuyere-front raceway temperature, and the specific heat of carbon at 2,400 degrees C. is 6 cal/kmol, the above heat capacity is calculated by as follows: (42/22.4) kmol×6 cal/kmol×(2400 degrees C.×0.75)=20.25×10³ kcal.
(3-4) Sum of heat input to the tuyere-front raceway: 103.6×10³ kcal

### Calculation of Tuyere-Front Raceway Temperature Tf

(4-1) Gas Volume in Raceway
Heat capacity of 79 Nm³ of N₂: 79/22.4×28×0.29×Tf=28.64 Tf
Heat capacity of 42 Nm³ of CO: 42/22.4×28×0.292×Tf=15.33 Tf

In the above, 28 is a molecular weight of each of N₂ and CO, and 0.29 and 0.292 are specific heats of N₂ and CO assuming that Tf is 2,300 degrees C.
(4-2) Raceway Temperature Tf
103.6×10³ kcal=(28.64Tf+15.33Tf)×10³ kcal
Tf=2,356 degrees C. is obtained by the above formula.
(4-3) The tuyere-front raceway temperature reaches as high as 2,356 degrees C. in an in all-coke operation. However, it is believed that the tuyere-front raceway temperature reaches approximately 2,100 degrees C. by injecting fine powdered coal in an actual operation.

### Blast Furnace Operation Method of Injecting All of CO₂-Removed CO Gas Through Blast Furnace Tuyere

### Comparative 2 (Table 1)

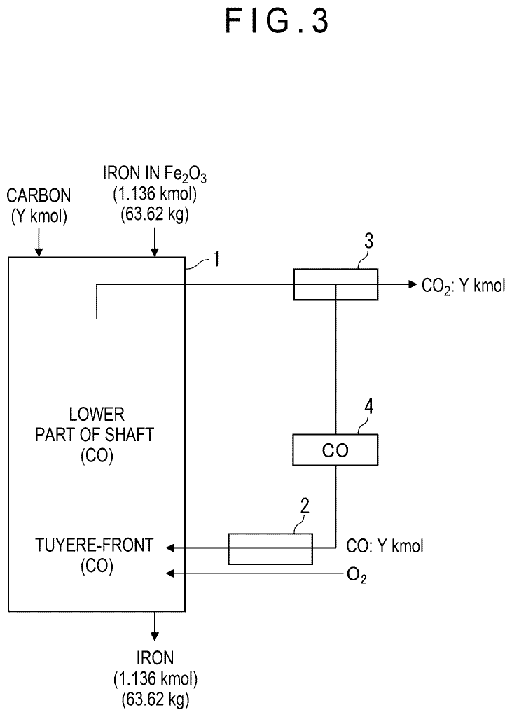

In this blast furnace operation method, O₂ is injected through the tuyere of the blast furnace 1, CO₂ is separated and removed from the blast furnace gas discharged from the blast furnace top, and all of the CO₂-removed CO gas is injected through the blast furnace tuyere without N₂ gas circulation (FIG. 3).

In the following, the CO gas injected through the blast furnace tuyere will be occasionally referred to as a “tuyere-injection CO gas”. After CO₂ is removed by a carbon dioxide capture and storage (CCS), all of the CO gas not contributing to reduction of ore is injected again through the tuyere. The tuyere-injection CO gas, which is discharged from the furnace top and entirely and repeatedly injected through the tuyere, totally turns into CO₂ to contribute to reduction of iron ore. This reduces the coke ratio and reduction in CO₂ is expectable.

### Premises of Blast Furnace Operation Method Involving Injection of All of CO₂-Removed Blast Furnace Gas Through Blast Furnace Tuyere

(5-1) In a normal blast furnace operation, air is injected through the tuyere to combust the coke in the furnace. The blast furnace gas thus contains nitrogen. It should be noted that the blast furnace gas is not discharged to the outside in the blast furnace operation in which all of the CO₂-removed blast furnace gas is injected through the blast furnace tuyere. In such an operation, if air is injected through the tuyere, N₂ is continuously delivered into the blast furnace to accumulate therein. In view of the above, in the blast furnace operation involving injection of all of the CO₂-removed blast furnace gas through the blast furnace tuyere, it is premised that O₂ without N₂ is injected, instead of air, during the operation.
(5-2) In the blast furnace operation, in which oxygen and all of the CO₂-removed CO gas are injected through the blast furnace tuyere, N₂ is not injected through the tuyere and the gas volume in the tuyere-front raceway is small, making the tuyere-front raceway temperature Tf high. An excessively high Tf makes it difficult to perform the blast furnace operation. It is thus necessary to keep the tuyere-front raceway temperature Tf at the same level as that in the normal operation.
(5-3) In the blast furnace operation in which all of the CO₂-removed CO gas is injected through the blast furnace tuyere, N₂ is not injected through the tuyere and the gas volume in the tuyere-front raceway is smaller than that in an operation in a current large blast furnace. This makes the heat flow ratio (a ratio between a heat capacity of a solid and a heat capacity of a gas) large and heat transfer from an in-furnace gas to the charge decreases, resulting in a difficulty in the blast furnace operation. It is necessary to keep the gas volume in the tuyere-front raceway at the same level as that in the normal operation.

### Total Heat Balance in Blast Furnace Involving Injection of CO₂-Removed CO Gas Through Blast Furnace Tuyere

In an operation illustrated in FIG. 3, the yield of iron is the same as that in the base operation (63.62 kg), where all of CO obtained by removing CO₂ from the furnace top gas is stored in a tuyere-injection gas relay tank 4, is heated to 1,200 degrees C. in the hot-blast stove 2, and is injected into the blast furnace through the blast furnace tuyere.

### Amount of Heat Input

It is assumed that an amount of carbon needed to produce 63.62 kg of iron (the same amount as in the base operation) is Y kmol.
(6-1) Heat input generated by combusting C (C to CO₂) is 94.05Y×10³ kcal. This is the formation heat of CO₂, that is, the heat generated when C combusted in the blast furnace turns into CO₂, (breakdown of the calculation: Y×393.5 kJ/mol×0.239 Cal/J×10³). CO gas is repeatedly injected through the tuyere to turn into CO₂. Thus, all of the charged carbon turns into CO₂. As described in “Basic Chemistry” 21nd edition (Shokabo Co., Ltd.), p. 132, a standard formation heat of gas in an oxidation process of C into CO₂(C+O₂=CO₂) is 66 H=−393.5 kJ/mol. Further, 1 J=0.239 cal is satisfied.
(6-2) The sensible heat of the tuyere-injection CO gas is 9.24Y×10³ kcal.

The breakdown of the calculation is (Y×28 kg×0.275 kcal/kg×1,200 degrees C.). The amount of the tuyere-injection CO gas is Y kmol (described below). The CO gas is heated to 1,200 degrees C. 28 kg is a molecular weight (kg/kmol) of CO and 0.275 kcal/kg is a specific heat of CO at 1,200 degrees C.

The amount of the tuyere-injection CO gas will be described below. When the charged carbon into the blast furnace is Y kmol, the injection amount of CO gas delivered via the tuyere-injection gas relay tank 4 is Y kmol. It is premised that the CO gas utilization efficiency ηCO is 50%. Thus, 0.5Y kmol of CO₂ is produced from Y kmol of the charged carbon and 0.5 Y kmol of CO₂ is produced from Y kmol of the tuyere-injection CO gas, resulting in Y kmol of CO₂ in total.

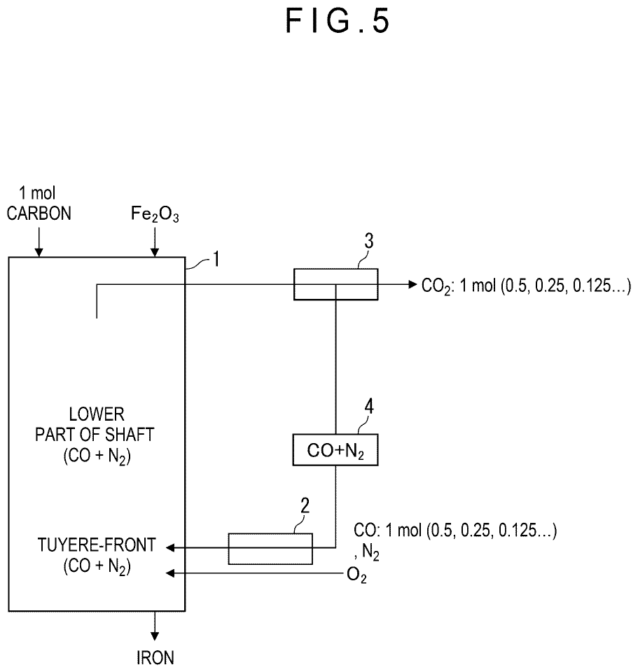

FIG. 5 illustrates that the tuyere-injection CO gas is 1 mol when 1 mol of carbon is charged into the blast furnace 1.

When 1 mol of carbon is charged into the blast furnace 1, assuming that the indirect reduction rate is 50%, a furnace top gas that contains (1) 0.5 mol of CO₂ and 0.5 mol CO is produced. Subsequently, when 0.5 mol of CO, (1) above, is injected through the tuyere via the tuyere-injection CO gas relay tank 4, the furnace top gas that contains (2) 0.25 mol of CO₂ and 0.25 mol of CO is produced. When 0.25 mol of CO, (2) above, is injected through the tuyere, the furnace top gas that contains (3) 0.125 mol of CO₂ and 0.125 mol of CO is produced. Similarly, 0.063 mol, 0.031 mol, . . . of CO is repeatedly injected through the tuyere. 1 mol of carbon charged in the blast furnace eventually turns into 1 mol (0.5+0.25+0.063+0.031 . . . ) of CO injected through the tuyere. When a tank is provided on the way and 1 mol of carbon is to be charged in the blast furnace, 1 mol of CO generated beforehand and stored in the tank is injected through the tuyere. Thus, when Y kmol of carbon is to be charged in the blast furnace, Y kmol of CO is injected from the tank through the tuyere.
(6-3) The sum of input is 103.3Y×10³ kcal.

The breakdown of the calculation is 94.05Y×10³ kcal+9.24Y×10³ kcal.

A heat amount of 77.5×10³ kcal is needed to produce 63.62 kg of iron (see (2-4) above). Since 103.3Y×10³ kcal=177.5×10³ kcal is satisfied, Y is 1.718 kmol. It is thus necessary to charge 1.718 kmol of carbon.

### Tuyere-Front Raceway Temperature Tf

In the blast furnace 1, iron ore charged from the furnace top is heated and reduced as descending in the furnace, eventually turns into high-temperature hot metal to be discharged from a lower part of the furnace. In this case, it is important to keep the heat balance in the lower part of the furnace as well as the heat balance in the entire furnace.

In the tuyere-injection-CO-gas operation, in which all of the blast furnace gas from which CO₂ has been removed is injected through the blast furnace tuyere, it is necessary to solely inject oxygen to prevent N₂ from accumulating in the blast furnace.

In such an operation, N₂ is not present in the tuyere-front raceway and the gas volume in the tuyere-front raceway is reduced. It is thus expectable that the tuyere-front raceway temperature Tf will increase. In the normal operation, the tuyere-front raceway temperature Tf is approximately 2,100 degrees C.

Further, the gas discharged from the tuyere-front raceway does not contain N₂, and thus it has a smaller volume than that in the normal operation, resulting in an excessively large heat flow ratio.

The tuyere-front raceway temperature Tf and the volume of the gas discharged from the tuyere-front raceway during the tuyere-injection-CO-gas operation will thus be calculated below.

### Heat Input to Tuyere-Front Raceway

(7-1) Heat input generated by combusting C (C to CO) is 45.74×10³ kcal.

The breakdown of the calculation is 2×0.866 kmol×110.5 kJ/mol×0.239 cal/J×10³.

Oxygen injected into the tuyere is calculated based on the oxygen balance, based on which the amount of combusted C is calculated. The amount of oxygen discharged from the furnace top when 1.718 kmol of carbon is charged is 1.718 kmol (CO₂) and the amount of oxygen taken away from the ore is 27.27 kg/32 kg=0.8522 kmol. Accordingly, the amount of oxygen injected to the tuyere is 1.718−0.8522=0.866 kmol. It should be noted that 27.27 kg is an amount of oxygen taken away from the iron ore as described above. The amount of CO generated is 2×0.866 kmol. The combustion heat of CO (C to CO) is 110.5 kJ/mol (i.e. the formation heat of CO is ΔH=−110.5 kJ/mol).
(7-2) The heat capacity of carbon entering the tuyere-front raceway is 23.38×10³ kcal.

The breakdown of the calculation is 2×0.866 kmol×6 cal/kmol×(3,000 degrees C.×0.75). The amount of C combusted by oxygen injected into the tuyere (0.866 kmol) is 2×0.866 kmol. 6 cal/kmol is a specific heat of carbon at 3,000 degrees C. and the tuyere-front raceway temperature Tf is assumed to be 3,000 degrees C. Further, the temperature of carbon entering the tuyere-front raceway is assumed to be 0.75 times as high as the tuyere-front raceway temperature Tf.
(7-3) The sensible heat of the tuyere-injection CO gas is 9.24×1.718=15.87 ×10³ kcal.

Y=1.718 is assigned to 9.24Y×10³ kcal (see (6-2) above).
(7-4) The sum of the heat input to the tuyere-front raceway is 84.99×10³ kcal.

The breakdown of the calculation is 45.74×10³ kcal+23.38×10³ kcal+15.87×10³ kcal.

### Amount of Gas Discharged From Raceway

The amount of CO discharged from the raceway is 96.6 kg.

CO is generated in front of the tuyere in accordance with a reaction formula of C+0.502=CO. 1.732 kmol of CO is generated per 0.866 kmol of oxygen injected into the tuyere. Accordingly, the amount of CO generated is 1.732×28=48.50 kg.

As described above, when the charged carbon into the blast furnace is Y kmol, the injection amount of CO gas delivered via the tuyere-injection gas relay tank 4 is Y kmol. Y kmol, which is equal to 1.718 kmol, is 48.10 kg. CO in front of the tuyere is 96.6 kg in total, which is equal to 96.6/28=3.45 kmol and 22.4×3.45=77.3 Nm³.

### Tuyere-Front Raceway Temperature Tf

The tuyere-front raceway temperature Tf is calculated based on an equation of (heat input to the tuyere-front raceway)=(heat output). The heat input is 84.99×10³ kcal (see (7-4) above). The heat output is 96.6 kg×0.297 kcal/kg×Tf. 0.297 kcal/kg is a specific heat of CO at 3,000 degrees C.

The tuyere-front raceway temperature Tf=2,962 degrees C. is obtained by 84.99×10³ kcal=96.6 kg×0.297 kcal/kg×Tf×10³ kcal.

The blast furnace operation method, in which all of the CO gas is injected through the tuyere, does not involve injection of N₂ into the tuyere, so that the tuyere-front raceway temperature Tf becomes as high as 2,962 degrees C. The temperature, which is greatly different from that in the normal operation, causes damage to the refractory and tuyere, making it impossible to perform the oxygen injection and the operation for circulating all of the blast furnace gas.

Further, CO discharged from the raceway is 77.3 Nm³ as described above, which is smaller than that in the normal operation (121 Nm³).

Blast Furnace Operation Method Involving Injection of Circulating N₂ Gas together with CO₂-removed CO gas through Blast Furnace Tuyere

### Inventive Example 1 (Table 1)

In this blast furnace operation method, O₂ is injected through the tuyere of the blast furnace, CO₂ is separated and removed from the blast furnace gas discharged from the blast furnace top, and all of the CO₂-removed CO gas is injected through the blast furnace tuyere, where circulating N₂ gas is injected through the blast furnace tuyere together with the CO₂-removed CO gas.

It is found that, according to the blast furnace operation method illustrated in FIG. 3 (Comparative 2) in which all of the CO₂-removed blast furnace gas is injected through the blast furnace tuyere, the tuyere-front raceway temperature Tf becomes too high to perform the operation. Measures to reduce the tuyere-front raceway temperature Tf will be described below.

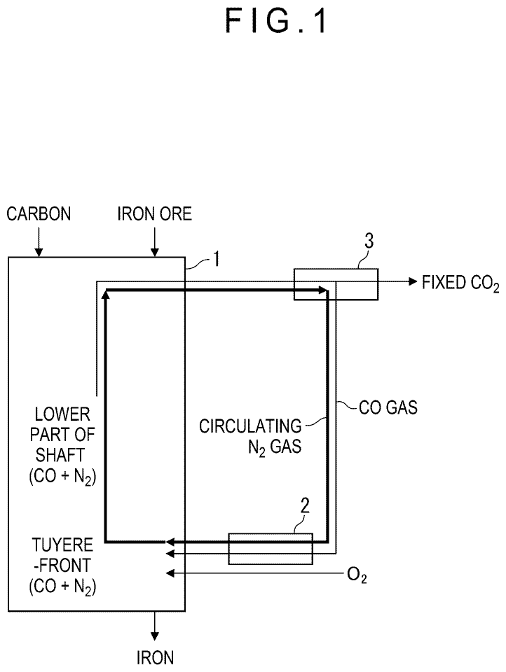

FIG. 1 is a conceptual diagram of a blast furnace operation method involving injection of the circulating N₂ gas together with the CO₂-removed blast furnace gas through the tuyere of the blast furnace 1. In the operation involving injection of the CO₂-removed blast furnace gas through the tuyere, the circulating N₂ gas is injected through the tuyere. 50% of the CO gas in the blast furnace turns into CO₂ whereas the rest (50%) of the CO gas stays unreacted, where the CO₂-removed CO is repeatedly injected through the tuyere to be totally turned into CO₂ in the end. In contrast, N₂ does not cause chemical reaction in the blast furnace, and only circulates within a circulation system of the blast furnace gas, that is, from the inside of the furnace to the furnace top and from the furnace top to the tuyere. It is only necessary that a predetermined amount of N₂ is contained in the blast furnace gas at the start of the operation. Unlike the blast delivered through the tuyere, N₂ is not continuously fed from the outside. N₂ does not burn in the tuyere-front raceway, and serves as a coolant for the tuyere-front raceway whose temperature is increased to a high temperature (2,962 degrees C.) by O₂ injected through the tuyere, thereby keeping the Tf at 2,100 degrees C. as in the base operation. Further, N₂ injected into the tuyere-front raceway allows the amount of gas generated in the tuyere-front raceway to be at the same level as that in the normal operation.

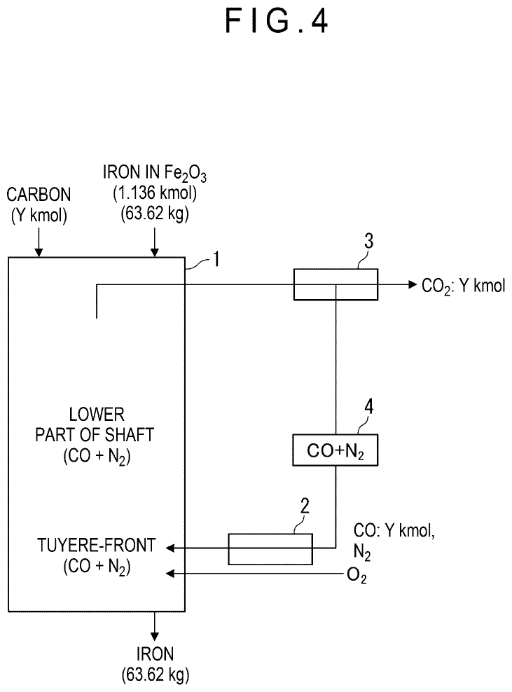

FIG. 4 illustrates a flow of a blast furnace operation method in which the circulating N₂ is injected together with the CO₂-removed blast furnace gas through the tuyere of the blast furnace 1. The flow illustrates a case where the same amount (63.62 kg) of iron as that in the base operation is produced. The circulating N₂ is stored in the tuyere-injection gas relay tank 4 together with the CO₂-removed CO gas. Subsequently, N₂ and CO gases discharged from the tuyere-injection gas relay tank 4 are heated by the existing hot-blast stove 2 to 1,000 degrees C. to 1,200 degrees C., and then injected through the blast furnace tuyere into the blast furnace 1. The heating of N₂ and CO gases by the hot-blast stove 2 is intended to reduce the amount of charged carbon for the purpose of reduction CO₂ discharge. The heating temperature may be determined in accordance with the amount of the circulating N₂ and a target Tf.

### Heat Input in Blast Furnace Operation Involving Injection of Circulating N₂ Gas Through Blast Furnace Tuyere

The blast furnace operation method, in which N₂ circulates together with the tuyere-injection CO gas, will be described below on the premise that the same amount (63.62 kg) of iron as that in the base operation is to be produced. It is assumed that the charged carbon in the blast furnace 1 is Y kmol.
(8-1) Heat input generated by combusting C (C to CO₂) is 94.05Y×10³ kcal. The breakdown of the calculation is Y×393.5 kJ/mol×0.239 Cal/J×10³ (see (6-1) above).
(8-2) The sensible heat of the tuyere-injection CO gas is 9.24Y×10³ kcal.

The breakdown of the calculation is Y×28 kg×0.275 kcal/kg×1,200 degrees C. (see (6-2) above).
(8-3) The sensible heat of circulating N₂ is W kmol×28 kg×0.272 kcal/kg×1,200 degrees C.=9.14W×10³ kcal.

It is assumed that N₂ circulating in the circulation system of the blast furnace gas is W kmol. This N₂ is fed to the blast furnace gas circulation system at the start of the blast furnace operation, and is not discharged out of the circulation system. Specifically, after switching air blast during the normal operation to an operation involving O₂ injection, a predetermined amount of N₂ may be circulated within the blast furnace. 28 kg is a molecular weight (kg/kmol) of N₂ and 0.272 kcal/kg is a specific heat of N₂ at 1,200 degrees C.

It should be noted that the injected oxygen is never heated for the sake of security, and thus the injected oxygen has no sensible heat.
(8-4) The sum of heat input is 103.3Y×10³ kcal+9.14W×10³ kcal.

The breakdown of the calculation is 94.05Y×10³ kcal+9.24Y×10³ kcal+9.14W×10³ kcal.

The yield of pig iron is the same (63.62 kg) as in the base operation. Accordingly, assuming that the required heat is the same as that in the base operation, the following equation (A) is established.

$$103.3 Y \times 1 {0}^{3} kcal + 9.14 W \times {10}^{3} kcal = 177.5 \times 1 {0}^{3} kcal \qquad ( A )$$

### Tuyere-Front Raceway Temperature Tf in Blast Furnace Operation Involving Injection of Circulating N₂ Gas Through Blast Furnace Tuyere

The tuyere-front raceway temperature becomes high due to the absence of N₂. Fine powdered coal is often injected in the normal blast furnace operation, where the tuyere-front raceway temperature Tf is set in a range from 2,000 degrees C. to 2,400 degrees C. Thus, in Inventive Example 1, the target value of the tuyere-front raceway temperature Tf is set at 2,100 degrees C., and W kmol of nitrogen is injected as a coolant gas.

### Heat Input

(9-1) The combustion heat of carbon in front of the tuyere is (52.82Y−45.01)×10³ kcal.

The breakdown of the calculation is (Y−27.27/32)×2×110.5 kJ/mol×0.239 cal/J.

Since the same amount (63.62 kg) of iron as that in the base operation is to be produced, oxygen contained in the ore is 27.27 kg.

The oxygen injected into the tuyere-front raceway is obtained by subtracting 27.27 kg of oxygen taken away from the ore from 32Y kg of oxygen contained in the furnace top gas, which is (32Y−27.27) kg equal to (Y−27.27/32) kmol.

2 kmol of CO is produced from 1 kmol of oxygen (2C+O₂=2CO). The formation heat of CO gas is ΔH=−110.5 kJ/mol.
(9-2) The sensible heat of the tuyere-injection CO gas is 9.24Y×10³ kcal. The breakdown of the calculation is (Y kmol×28 kg×0.275 kcal/kg×1,200 degrees C.) (see (6-2) above).
(9-3) The sensible heat of the circulating N₂ is 9.14W×10³ kcal.

The breakdown of the calculation is W kmol×28 kg×0.272×1,200 degrees C. (see (8-3) above).
(9-4) Heat capacity of carbon entering the tuyere-front raceway is (18.9Y−16.12)×10³ kcal.

The breakdown of the calculation is (Y−27.27/32)×2 kmol×6 cal/mol×2,100 degrees C.×0.75.

(Y−27.27/32)×2 kmol is an amount of carbon entering the tuyere-front raceway. 6 cal/kmol is a specific heat of carbon at 2,100 degrees C. and the temperature of carbon entering the tuyere-front raceway is assumed to be 0.75 times as high as the tuyere-front temperature.
(9-5) The sum of heat input is (80.96Y+9.14W−61.13)×10³ kcal.

The breakdown of the calculation is (52.82Y−45.01)×10³ kcal+9.24Y×10³ kcal+9.14W×10³ kcal+(18.9Y−16.12)×10³ kcal.

### Heat Output

An amount Y of carbon charge and an amount W of circulating N₂ are determined so that the tuyere-front raceway temperature Tf reaches 2,100 degrees C.
(10-1) CO is heated by (50.98Y−28.96)×10³ kcal.

The breakdown of the calculation is ((Y27.27/32)×2+Y)×28 kg×0.289 kcal/kg×2,100 degrees C. 0.289 kcal/kg is a specific heat of CO at 2,100 degrees C.
(10-2) N₂ is heated by 16.82W×10³ kcal.

The breakdown of the calculation is W kmol×28 kg×0.286 kcal/kg×2,100 degrees C. 0.286 kcal/kg is a specific heat of N₂ at 2,100 degrees C.
(10-3) The sum of heat output is (50.98Y−28.96)×10³ kcal+16.82 W×10³

### Heat Balance

### Heat Balance in Tuyere-Front Raceway:

$$29.98 Y \times 1 {0}^{3} kcal - 7.68 W \times 1 {0}^{3} kcal = 32.16 \times 1 {0}^{3} kcal \qquad ( B )$$

The breakdown of the calculation is, assuming that (the sum of heat input)=(the sum of heat output), (80.96Y+9.14W−61.12)×10³ kcal=(50.98Y−28.96)×10³ kcal+16.82W×10³ kcal.

### Carbon Charge Amount Y and N₂ Gas Circulation Amount W

The above formulae (A) and (B) are solved as equations with two unknowns to calculate the carbon charge amount Y and the circulating N₂ amount W.
Carbon charge amount Y: 1.553 kmol, which shows 34.9% reduction in CO₂ with respect to 2.386 in the base operation
N₂ circulation amount W: 1.875 kmol (42 Nm³)

### Composition and Volume of Gas in Tuyere-Front Raceway

CO: 66.2 Nm³

The breakdown of the calculation is (Y−27.27/32)×2+Y)=(3×Y−1.7044) kmol. When Y=1.553 kmol is assigned to the above formula, 2.955 kmol=66.2 Nm³ is obtained.
N₂: 42.0 Nm³ (1.875 kmol)

A total gas volume of CO and N₂ is 108.2 Nm³.

### Blast Furnace Operation Method Involving Injection of Circulating N₂ Gas Through Blast Furnace Tuyere, Keeping Gas Volume in Tuyere-Front Raceway

### Inventive Example 2 (Table 1)

In Inventive Example 1, when the circulating N₂ is 42.0 Nm³, the tuyere-front raceway temperature Tf is 2,100 degrees C. and the gas volume in the tuyere-front raceway is 108.2 Nm³. The gas volume in the tuyere-front raceway is smaller than the gas volume 121 Nm³ during the base operation. A small volume of the gas generated in the tuyere-front raceway makes the heat flow ratio large, which may cause a situation where heat transfer from the in-furnace gas to the charge is insufficient.

In view of the above, measures to make the gas volume in the tuyere-front raceway close to the gas volume (121 Nm³) during the base operation will be studied in Inventive Example 2. In order to maintain the gas volume in front of the tuyere and make the heat flow ratio at the substantially same level as that in the base operation, the volume of the circulating N₂ can be increased. The amount of charged carbon is increased to increase the heat input with the amount of charged ore kept constant so that Tf reaches 2, 100 degrees C. even with an increase in N₂. The gas volume in the tuyere-front raceway increases due to the increase in volume of N₂ and the increase in volume of CO in front of the tuyere caused by the increase in amount of the charged carbon.

Specifically, the heat balance and the tuyere-front raceway temperature Tf when the value of the heat input in Inventive Example 1 (177.5×10³ kcal) is gradually increased by increasing the charged carbon are calculated. When the gas volume is calculated as described below based on a formula (A′), in which the amount of heat input in the above formula (A) is changed to 190×10³ kcal, and the formula (B), the gas volume in the tuyere-front raceway is 122 Nm³.

$$103.3 Y \times 1 {0}^{3} kcal + 9.14 W \times 1 {0}^{3} kcal = 190 \times 1 {0}^{3} kcal \qquad ( {A}^{′} )$$

$$29.9 8 Y \times 1 {0}^{3} kcal - 7.68 W \times 1 {0}^{3} kcal = 32.16 \times 1 {0}^{3} kcal \qquad ( B )$$

### Carbon Charge Amount Y and N₂ Gas Circulation Amount W

The above formulae (A′) and (B) are solved as equations with two unknowns to calculate the carbon charge amount Y and the circulation amount W of the blast furnace gas.
Carbon charge amount Y: 1.643 kmol, which shows 31.1% reduction in CO₂ with respect to 2.386 in the base operation.
N₂ circulation amount W: 2.224 kmol (49.8 Nm³)

### Composition and Volume of Gas in Front of Tuyere

CO: 72.2 Nm³

The breakdown of the calculation is (3×Y−1.7044) kmol (see the breakdown of the calculation in Inventive Example 1). When Y=1.643 kmol is assigned to the above formula, 3.225 kmol=72.2 Nm³ is obtained.
N₂: 49.8 Nm³ (2.224 kmol)

A total gas volume of CO and N₂ is 122 Nm³.

### Blast Furnace Operation Method Involving Injection of Blast Furnace Gas Containing CO Gas and H₂ Through Tuyere

### Comparative 3 (Table 1)

When the blast furnace gas is injected through the tuyere without injecting N₂ gas, the tuyere-front raceway temperature reaches as high as 2,962 degrees C., making it impossible to perform the blast furnace operation. In view of the above, a case in which hydrogen gas is concurrently used as a coolant gas for the tuyere-front raceway will be described below. In this case, H₂ is added without N₂ circulation.

### Heat Input

It is assumed that the charged carbon in the blast furnace 1 is Y kmol.
(11-1) Heat input generated by combusting C (C to CO₂) is 94.05Y×10³ kcal.

The breakdown of the calculation is Y×393.5 kJ/mol×0.239 Cal/J×10³ kcal (see (6-1) above).
(11-2) The sensible heat of the tuyere-injection CO gas is 9.24Y×10³ kcal.

The breakdown of the calculation is Y×28 kg×0.275 kcal/kg×1,200 degrees C. (see (6-2) above).
(11-3) Heat input generated by combusting H₂ (H₂ to H₂O) is 57.79Z×10³ kcal.

The breakdown of the calculation is Z×241.8 kJ/mol×0.239 kcal/kJ×10³ kcal. It is assumed that Z kmol of hydrogen is injected. 241.8 kJ/mol is a formation heat of H₂O (g).
(11-4) The sensible heat of H₂ injected through the tuyere is 8.573Z×10³ kcal.

The breakdown of the calculation is (Z×2 kg×3.572 kcal/kg×1,200 degrees C.). 3.572 kcal/kg is a specific heat of hydrogen at 1,200 degrees C.
(11-5) The sum of heat input is (103.3Y+66.36Z)×10³ kcal.

The breakdown of the calculation is 94.05Y×10³ kcal+9.24Y×10³ kcal+57.79Z×10³ kcal+8.573Z×10³ kcal.
(11-6) Heat Balance of Entire Furnace:

The production is the same as that (63.62 kg) in the base operation. Thus, assuming that the amount of heat output is also the same (177.5×10³ kcal), the following formula (A″) is established based on the equation of (the sum of heat input)=(the sum of heat output).

$$( 103.3 Y + 66.36 Z ) \times 1 {0}^{3} kcal = 177.5 \times 1 {0}^{3} kcal \qquad ( {A}^{″} )$$

### Heat Balance in Tuyere-Front Raceway

The tuyere-front raceway temperature becomes high due to the absence of N₂. Thus, the target value of the tuyere-front raceway temperature Tf is set at 2,100 degrees C., and Z kmol of hydrogen is injected through the tuyere as a coolant gas.

### Heat Input

(12-1) The combustion heat of carbon in front of the tuyere is (52.82Y+26.41Z−45.01)×10³ kcal.

The breakdown of the calculation is (Y+0.5Z−27.27/32)×2×110.5 kJ/mol×0.239 cal/J×10³ kcal. Oxygen contained in the furnace top gas is (32Y+16Z) kg and oxygen injected into the tuyere-front raceway is (32Y+16Z−27.27) kg=(Y+0.5Z−27.27/32) kmol. 27.27 kg is an amount of oxygen taken away from the ore. 2 kmol of CO is produced from 1 kmol of oxygen (2C+O₂=2CO). The formation heat of CO gas is ΔH=−110.5 kJ/mol.
(12-2) Heat capacity of carbon entering the tuyere-front raceway is (18.9Y+9.45Z−16.11)×10³ kcal.

The breakdown of the calculation is (Y+0.5Z−27.27/32)×2 kmol×6 cal/mol×2,100 degrees C.×0.75.
(12-3) The sensible heat of CO injected through the tuyere is 9.24Y×10³ kcal (see (6-2) above).
(12-4) The sensible heat of H₂ injected through the tuyere is 8.573Z×10³ kcal (see (11-4) above).
(12-5) The sum of heat input is (80.96Y+44.43Z−61.12)×10³ kcal.

The breakdown of the calculation is (52.82Y+26.41Z−45.01)×10³ kcal+(18.9Y+9.45Z−16.11)×10³ kcal+9.24Y×10³ kcal+8.573Z×10³ kcal.

### Heat Output: Hydrogen is Added so That the Tuyere-Front Raceway Temperature Reaches 2,100 Degrees C.

(13-1) CO is heated by (50.98Y+17.00Z−28.97)×10³ kcal.

The breakdown of the calculation is ((Y+0.5Z−27.27/32)×2+Y) kmol×28 kg×0.289 kcal/kg×2,100 degrees C. (Y+0.5Z−27.27/32)×2 kmol is a molar quantity of CO generated in front of the tuyere, Y is a molar quantity of CO injected through the tuyere, 28 is a molecular weight of CO, and 0.289 kcal/kg is a specific heat of CO at 2,100 degrees C.
(13-2) H₂ injected through the tuyere is heated by 31.62Z×10³ kcal.

The breakdown of the calculation is (Z+Z)×2 kg×3.764 kcal/kg×2,100 degrees C.×10³kcal. Z+Z is an amount of initially injected hydrogen and hydrogen injected through the tuyere via the relay tank, and 3.764 kcal/kg is a specific heat of H₂ at 2,100 degrees C.
(13-3) The sum of heat output is (50.98Y+48.62Z−28.97)×10³ kcal.

The breakdown of the calculation is (50.98Y+17.00Z−28.97)×10³ kcal+31.62Z×10³ kcal.

### Heat Balance in Tuyere-Front Raceway

### Heat Balance in Tuyere-Front Raceway:

29.98Y−4.19Z=32.15 . . . (B′)

The breakdown of the calculation is (80.96Y+44.43Z−61.12)×10³ kcal=(50.98Y+48.62Z−28.97)×10³ kcal.

### Carbon Charge Amount Y and Hydrogen Injection Amount Z

The above formulae (A″) and (B′) are solved as equations with two unknowns to calculate the carbon charge amount Y and the hydrogen injection amount Z.
Carbon charge amount Y: 1.188 kmol
hydrogen injection amount Z: 0.826 kmol

### Gas Volume in Tuyere-Front Raceway

When Y=1.188 and Z=0.826 are assigned to calculate the volume of CO, CO=60.2 Nm³ is obtained.

The breakdown of the calculation is ((Y+0.5Z−27.27/32)×2+Y) kmol=3Y+Z−1.704=2.686 kmol=60.2 Nm³.
H₂: 37.0 Nm³

When Z=0.826 mol is assigned to (Z+Z) kmol, 1.65 kmol=37 Nm³ is obtained.
A total gas volume of CO and H₂ is 97.2 Nm³.
   Blast Furnace Operation Method Involving Circulation of N₂ as Well as Injection of Blast Furnace Gas Containing CO Gas and H₂

### Inventive Example 3 (Table 1)

In a blast furnace operation method (Comparative 3) involving injection of H₂ as well as CO and H₂ injected through the tuyere, the gas volume in the tuyere-front raceway is 97 Nm³, which is smaller than 121 Nm³ in the base operation.

Thus, circulating N₂ is added to the tuyere-injection CO gas and H₂ to increase the gas volume in the tuyere-front raceway. The entire heat balance of the blast furnace 1 and the tuyere-front raceway Tf are calculated by changing the addition amount of N₂. Assuming that the circulating N₂ amount is W=1 kmol and the charged carbon is increased to make the amount of heat input 200×10³ kcal, the gas volume in the tuyere-front raceway reaches 120 Nm³, which is substantially equal to that in the base operation. The breakdown of the calculation will be described below.

### Heat Requirement in Inventive Example 3

### Heat Input

It is assumed that the charged carbon in the blast furnace 1 is Y kmol.
(14-1) Heat input generated by combusting C (C to CO₂) is 94.05Y×10³ kcal. The breakdown of the calculation is Y×393.5 kJ/mol×0.239 Cal/J×10³ kcal (see (6-1) above).
(14-2) The sensible heat of the tuyere-injection CO gas is 9.24Y×10³ kcal. The breakdown of the calculation is Y×28 kg×0.275 kcal/kg×1,200 degrees C. (see (6-2) above).
(14-3) Heat input generated by combusting H₂ (H₂ to H₂O) is 57.79Z×10³ kcal.

The breakdown of the calculation is Z×241.8 kJ/mol×0.239 kcal/kJ×10³ kcal (see (11-3) above). (14-4) The sensible heat of H₂ injected through the tuyere is 8.573Z×10³ kcal.

The breakdown of the calculation is Z×2 kg×3.572 kcal/kg×1,200 degrees C. (see (11-4) above).
(14-5) The sensible heat of the circulating N₂ is 9.14×10³ kcal. W=1 kmol is assigned to 9.14W×10³ kcal (see (8-3) above).
(14-6) The sum of heat input is (103.3Y+66.36Z+9.14)×10³ kcal.

The breakdown of the calculation is 94.05Y×10³ kcal+9.24Y×10³ kcal+57.79Z×10³ kcal+8.573Z×10³kcal+9.14×10³ kcal.
(14-7) Heat Balance of Entire Furnace:

The production is the same as that (63.62 kg) in the base operation. However, under the presence of circulating N₂, the heat requirement increases to prevent a decrease in the tuyere-front raceway temperature, and thus the charged carbon Y is slightly increased. When the heat requirement is changed, the heat requirement of a formula (A″) matching the above formula (B) defining the tuyere-front raceway temperature is 200×10³ kcal.

$$( 103.3 Y + 66.36 Z + 9.14 ) \times 1 {0}^{3} kcal = 200 \times 1 {0}^{3} kcal \qquad ( {A}^{″′} )$$

The following formula is obtained by moving the constant term to the right-side member.

$$( 103.3 Y + 66.36 Z ) \times 1 {0}^{3} kcal = 190.9 \times 1 {0}^{3} kcal$$

### Tuyere-Front Raceway

### Heat Input

(15-1) The combustion heat of carbon in front of the tuyere is (52.82Y+26.41Z−45.01)×10³ kcal.

The breakdown of the calculation is (Y+0.5Z−27.27/32)×2×110.5 kJ/mol×0.239 cal/J×10³ kcal (see (12-1) above).
(15-2) Heat capacity of carbon entering the tuyere-front raceway is (18.9Y+9.45Z−16.11)×10³ kcal.

The breakdown of the calculation is (Y+0.5Z−27.27/32)×2 kmol×6 cal/mol×2,100 degrees C.×0.75 (see (12-2) above).
(15-3) The sensible heat of CO injected through the tuyere is 9.24Y×10³ kcal (see (6-2) above).
(15-4) The sensible heat of H₂ injected through the tuyere is 8.573Z×10³ kcal (see (11-4) above).
(15-5) The sensible heat of the circulating N₂ is 9.14×10³ kcal.

W=1 kmol is assigned to 9.14W×10³ kcal (see (8-3) above).
(15-6) The sum of heat input is (80.96Y+44.43Z+−51.98)×10³ kcal.

The breakdown of the calculation is (52.82Y+26.41Z−45.01)×10³ kcal+(18.9Y+9.45Z−16.11)×10³ kcal+9.24Y×10³ kcal+8.573Z×10³ kcal+9.14×10³ kcal.

### Heat Output

(16-1) CO is heated by (50.98Y+17.00Z−28.97)×10³ kcal (see (13-1) above).
(16-2) H₂ is heated by 31.62Z×10³ kcal (see (13-2) above).
(16-3) N₂ is heated by 16.82×10³ kcal.

W=1 kmol is assigned to 16.82W×10³ kcal (see 10-2 above). (16-4) The sum of heat output is (50.98Y+48.62Z−12.15)×10³ kcal.

### Heat Balance in Tuyere-Front Raceway

### Heat Balance in Tuyere-Front Raceway:

29.98Y−4.19Z=39.83 . . . (B″)

The breakdown of the calculation is (80.96Y+44.43Z−51.98)×10³ kcal=(50.98Y+48.62Z−12.15)×10³ kcal.

### Carbon Charge Amount Y and N₂ Amount W

The above formulae (A″) and (B″) are solved as equations with two unknowns to calculate the carbon charge amount Y and the N₂ amount W.
Carbon charge amount Y: 1.421 kmol, which shows 40.4% reduction in CO₂
N₂ injection amount W: 1 kmol
Hydrogen injection amount Z: 0.6641 kmol

### Gas Volume in Tuyere-Front Raceway

CO: 72.2 Nm³

The breakdown of the calculation is ((Y+0.5Z−27.27/32)×2+Y) kmol=3Y+Z−1.704=3.223 kmol=72.2 Nm³.
H₂: 27.5 Nm³

When Z=0.6641 kmol is assigned to (Z+Z) kmol, 1.328 kmol=29.7 Nm³ is obtained.
N₂: 1 kmol=22.4 Nm³
A total gas volume of CO, H₂, and N₂ is 124.3 Nm³.

### Blast Furnace Operation Method Involving Injection of Part of CO₂-Removed CO Gas Through Blast Furnace Tuyere

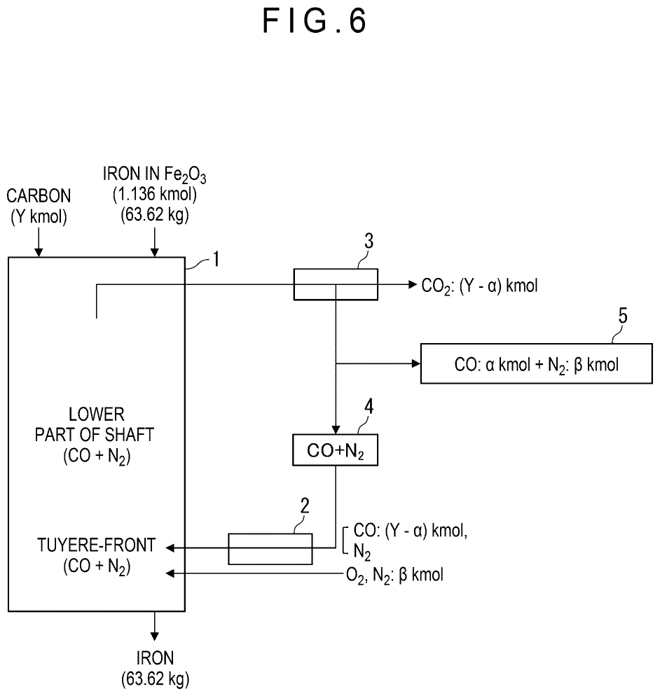

FIG. 6 illustrates a blast furnace operation method involving injection of a part of CO₂-removed blast furnace gas through the tuyere of the blast furnace 1. Some of iron ores to be used in the blast furnace 1 contain, for instance, impurities such as Zn and Pb. When an operation involving injection of all of the CO₂-removed blast furnace gas through the tuyere of the blast furnace is continued, such impurities accumulate in the blast furnace 1, which may cause trouble in the operation. Such impurities are blown out of the blast furnace 1 until the base operation is switched to the operation involving injection of CO gas through the tuyere according to the invention after a non-operation period of the blast furnace. However, the impurities are not blown out sufficiently at the start of operation after the non-operation period, or some of the impurities may be required to be constantly blown out. In such a case, a part of the blast furnace gas may be blown out into a blast furnace gas holder 5.

The above-described operation involving blowing a part of the blast furnace gas out of the furnace is usable as an intermediate step between the base operation and the operation involving injection of all of the blast furnace gas through the tuyere. In this case, a part of the circulating N₂ gas is blown out together with the blast furnace gas to be blown out. It is thus necessary to supplement the circulating N₂ gas to compensate for the N₂ gas blown out. The circulating N₂ gas is optionally supplemented using the blast.

Although a part of CO gas and N₂ gas is injected through the tuyere in the operation illustrated in FIG. 6, a part of the blast furnace gas containing CO gas, H₂ gas, and N₂ gas is optionally injected through the tuyere in the operation.

### Summary of Injection of Blast Furnace Gas Containing N₂ Through Tuyere

It is expected that world population will increase in the future. If consumption of steel increases especially in developing countries to the same level as that in advanced countries, the demand for steel will increase worldwide. Various measures such as a use of H₂ have been studied to reduce CO₂ discharge in the blast furnace 1. However, operation of existing large blast furnaces (e.g. 4000 m³ or 5000 m³ class) is indispensable to meet the demand for steel in the future. In this case, it is desirable that reduction in CO₂ discharge is achieved as the extension of current blast furnace technique. The invention provides conditions similar to those in existing blast furnaces in terms of the gas volume in the blast furnace and the tuyere-front raceway temperature Tf during the blast furnace operation, and thus is usable for the reduction in CO₂ discharge.

TABLE 1

| | | | | | | | Inventive | | | | Inventive | |
|---|---|---|---|---|---|---|---|---|---|---|---|---|
| | | | | | | | Ex. 2 | | | | Ex. 3 | |
| | | | | | | | CO | | | | CO, H₂ | |
| | | | | | Inventive | | injection, N2 | | | | injection, N₂ | |
| | | | | | Ex. 1 | | circulation | | | | circulation | |
| | Comp. 1 | | Comp. 2 | | CO | | Tuyere-Front | | Comp. 3 | | Tuyere-Front | |
| | Base | | CO | | injection, N₂ | | Gas Volume | | CO, H₂ | | Gas Volume | |
| | Operation | | injection | | circulation | | Being Kept | | injection | | Being Kept | |
| | Air | | Oxygen | | Oxygen | | Oxygen | | Oxygen | | Oxygen | |
| Case | Injection | | Injection | | Injection | | Injection | | Injection | | Injection | |
| Iron Yield | 63.62 | kg | 63.62 | kg | 63.62 | kg | 63.62 | kg | 63.62 | kg | 63.62 | kg |
| Charged Carbon | 2.386 | kmol | 1.718 | kmol | 1.553 | kmol | 1.643 | kmol | 1.188 | kmol | 1.421 | kmol |
| | 450 | kg/tFe | 324 | kg/tFe | 293 | kg/tFe | 310 | kg/tFe | 224 | kg/tFe | 268 | kg/tFe |
| Circulating N₂ | — | | — | | 1.875 | kmol | 2.224 | kmol | — | | 1 | kmol |
| Added Hydrogen | — | | — | | — | | — | | 0.826 | kmol | 0.664 | kmol |
| | | | | | | | | | 304 | Nm³/tFe | 216 | Nm³/tFe |
| Used Amount of | 0 | | — | | 236 | Nm³/pig | 266 | Nm³/pig | 252 | Nm³/pig | 303 | Nm³/pig |
| Pure Oxygen★ | | | | | | | | | | | | |
| Tuyere-Front Gas CO | 42 | | 77 | | 66 | | 72 | | 60 | | 72.2 | |
| N₂ | 79 | | — | | 42 | | 50 | | 0 | | 22.4 | |
| H₂ | — | | — | | 0 | | 0 | | 37 | | 29.7 | |
| Total | 121 | Nm³ | 77 | Nm³ | 108 | Nm³ | 122 | Nm³ | 97 | Nm³ | 124 | Nm³ |
| Tuyere-Front | 2,356° | C.★★ | 2,962° | C. | 2,100° | C. | 2,100° | C. | 2,100° | C. | 2,100° | C. |
| Temperature | | | | | | | | | | | | |

| | | | | | | |
|---|---|---|---|---|---|---|
| CO₂ Reduction | Base | Unable to Operate | 35% | 31% | 50% | 40% |

★Carbon component in pig iron is assumed to be 4.5%.
★★Theoretically 2,356 degrees C. in all-coke operation. However, due to injection of fine powdered coal, approximately 2,100 degrees C. in an actual operation.

### Blast Furnace Operation Method of Circulating Part of CO₂ Gas in Blast Furnace

### Inventive Example 4 (Table 2)

In the blast furnace operation involving injection of oxygen, CO₂ gas is circulated as in N₂ gas circulation to increase the gas volume in the tuyere front, preventing the increase in the tuyere-front raceway temperature Tf and the reduction in gas volume in the tuyere-front raceway.

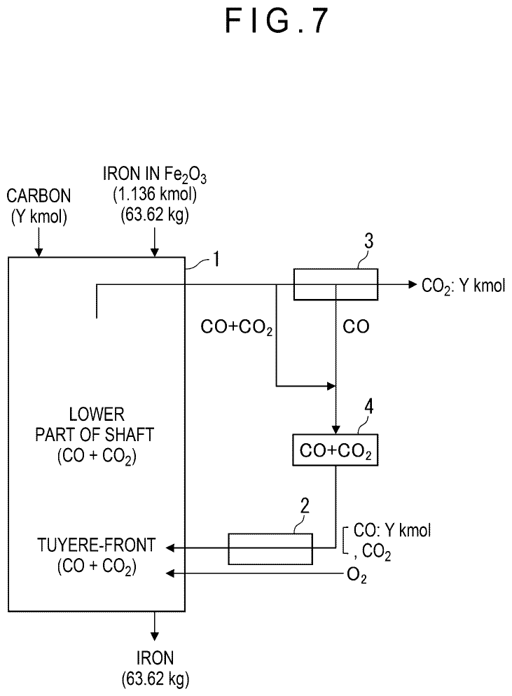

FIG. 7 illustrates an exemplary blast furnace operation method of circulating a part of CO₂ gas in the blast furnace.

O₂ gas is injected through the tuyere, CO₂ is separated and removed from a part of the blast furnace gas discharged from the blast furnace top, and all of the CO₂-removed CO gas is injected together with the rest of the blast furnace gas not separating and removing CO₂ from the blast furnace gas discharged from the blast furnace top through the blast furnace tuyere.

From a part of the blast furnace gas (CO+CO₂) discharged from the blast furnace 1, CO₂ is separated and removed by a CCS 3 (Carbon dioxide Capture and Storage). The rest of the blast furnace gas is stored in the tuyere-injection gas relay tank 4 without passing through the CCS 3. After that, CO₂ and CO gas discharged from the tuyere-injection gas relay tank 4 are heated by the existing hot-blast stove 2 to 1,000 degrees C. to 1,200 degrees C. and then injected through the blast furnace tuyere into the blast furnace 1. The heating of CO₂ and CO gases by the hot-blast stove 2 is intended to reduce the amount of charged carbon for the purpose of reduction CO₂ discharge.

In FIG. 7, the gas relay tank 4 stores all of the CO gas contained in the furnace top gas. Since the furnace top gas without passing through the CCS 3 is mixed thereinto, a certain amount of CO₂ is contained in the gas in the gas relay tank 4.

By injecting a certain amount of CO₂ gas through the tuyere together with the CO gas, the tuyere-front raceway temperature Tf and the gas volume in the tuyere-front raceway are kept substantially at the same level as those in the base operation, making it possible to reduce the charged carbon and consequently the CO₂ discharge from the blast furnace.

### Heat Input in Blast Furnace Operation Involving Injection of Circulating CO₂ Gas Through Blast Furnace Tuyere

The blast furnace operation method, in which CO₂ gas circulates together with the tuyere-injection CO gas, will be described below on the premise that the same amount (63.62 kg) of iron as that in the base operation is to be produced. It is assumed that the charged carbon in the blast furnace 1 is Y kmol.
(17-1) Heat input generated by combusting C (C to CO₂) is 94.05Y×10³ kcal.

The breakdown of the calculation is Y×393.5 kJ/mol×0.239 Cal/J×10³ (see (6-1) above).
(17-2) The sensible heat of the tuyere-injection CO gas is 9.24Y×10³ kcal.

The breakdown of the calculation is Y×28 kg×0.275 kcal/kg×1,200 degrees C. (see (6-2) above).
(17-3) The sensible heat of the circulating CO₂ gas is W kmol×44 kg×0.277 kcal/kg×1,200 degrees C.=14.63W×10³ kcal.

It is assumed that CO₂ circulating in the circulation system of the blast furnace gas is W kmol. 44 kg is a molecular weight (kg/kmol) of CO₂ and 0.277 kcal/kg is a specific heat of CO₂ at 1,200 degrees C.
(17-4) The sum of heat input is 103.3Y×10³ kcal+14.63W×10³ kcal.

The breakdown of the calculation is 94.05Y×10³ kcal+9.24Y×10³ kcal+14.63W×10³ kcal.

The yield of pig iron is the same (63.62 kg) as in the base operation. Accordingly, assuming that the required heat is the same as that in the base operation, the following equation (C) is established.

$$103.3 Y \times 1 {0}^{3} kcal + 14.63 W \times 1 {0}^{3} kcal = 177.5 \times 1 {0}^{3} kcal \qquad ( C )$$

### Tuyere-Front Raceway Temperature Tf in Blast Furnace Operation Involving Injection of Circulating CO₂ Gas Through Blast Furnace Tuyere

### Heat Input

(18-1) The combustion heat of carbon in front of the tuyere is (52.82Y−45.01)×10³ kcal.

The breakdown of the calculation is (Y−27.27/32)×2×110.5 kJ/mol×0.239 cal/J (see (9-1) above).
(18-2) The sensible heat of the tuyere-injection CO gas is 9.24Y×10³ kcal.

The breakdown of the calculation is (Y kmol×28 kg×0.275 kcal/kg×1,200 degrees C.) (see (6-2) above).
(18-3) The sensible heat of CO₂ injected through the tuyere is 14.63W×10³ kcal.

The breakdown of the calculation is W kmol×44 kg×0.277×1,200 degrees C.
(18-4) The (endothermic) reaction heat of CO₂ and C in front of the tuyere is −41.22W×10³ kcal.

CO₂ reacts chemically with C in front of the tuyere, as follows.

$${CO}_{2} + C = 2 CO$$

$$Δ H = + 1 72.5 kJ / kmol {CO}_{2}$$

The reaction heat for W kmol is 172.5 kJ/kmol×0.239 cal/J×10³ kcal.
(18-5) Heat capacity of carbon entering the tuyere-front raceway is (18.9Y+9.45W−16.12)×10³ kcal.

In the above, the heat capacity of C combusted by oxygen is (18.9Y−16.12)×10³ kcal (see (9-4) above). Further, the heat capacity of C that reacts with CO₂ in front of the tuyere is 9.45W×10³ kcal. The reaction heat of 1 kmol of CO₂, which reacts with 1 kmol of C, is W kmol×6 cal/mol×2,100 degrees C.×0.75 (see (9-4) above).
(18-6) The sum of the heat input to the tuyere-front raceway is the sum of the above (18-1) to (18-5), which is (80.96Y−17.14W−61.13)×10³ kcal.

### Heat Output

An amount Y of carbon charge and an amount W of circulating CO₂ are determined so that the tuyere-front raceway temperature Tf reaches 2, 100 degrees C.
(19-1) CO is heated by (50.98Y−28.96)×10³ kcal.

The breakdown of the calculation is ((Y−27.27/32)×2+Y)×28 kg×0.289 kcal/kg×2,100 degrees C. (see (10-1) above).
(19-2) The amount of heat applied to CO by the reaction of CO₂ and C is 34.0W×10³ kcal.

The breakdown of the calculation is 2W kmol×28 kg×0.289 kcal/kg×2,100 degrees C.
(19-3) The sum of heat output is (50.98Y+34.0W−28.96)×10³ kcal.

### Heat Balance

### Heat Balance in Tuyere-Front Raceway:

$$29.98 Y \times 1 {0}^{3} kcal - 51.14 W \times 1 {0}^{3} kcal = 32.16 \times 1 {0}^{3} kcal \qquad ( D )$$

The breakdown of the calculation is, assuming that (the sum of heat input)=(the sum of heat output), (80.96Y−17.14W−61.12)×10³ kcal=(50.98Y+34.0W−28.96)×10³ kcal.

### Carbon Charge Amount Y and CO₂ Gas Circulation Amount W

The above formulae (C) and (D) are solved as equations with two unknowns to calculate the carbon charge amount Y and the circulating CO₂ amount W.
Carbon charge amount Y: 1.669 kmol, which shows 30.0% reduction in CO₂ with respect to 2.386 in the base operation
CO₂ circulation amount W: 0.349 kmol

### Composition and Volume of Gas in Tuyere-Front Raceway

CO: 74.0 Nm³

The breakdown of the calculation is (3×Y−1.7044) kmol (see the description in Inventive Example 1). When Y=1.669 kmol is assigned to the above formula, 3.302 kmol=73.96 Nm³ is obtained.
CO generated by the reaction of CO₂ and C: 15.7 Nm³=2×0.349 kmol

A total gas volume is 89.7 Nm³.

### Blast Furnace Operation Method Involving Injection of Circulating CO₂ Gas Through Blast Furnace Tuyere, Keeping Gas Volume in Tuyere-Front Raceway

### Inventive Example 5 (Table 2)

In Inventive Example 4, when the circulating CO₂ is 0.349 kmol, the tuyere-front raceway temperature Tf is 2,100 degrees C. and the gas volume in the tuyere-front raceway is 89.7 Nm³. The gas volume in the tuyere-front raceway is smaller than the gas volume 121 Nm³ during the base operation. In view of the above, measures to make the gas volume in the tuyere-front raceway close to the gas volume (121 Nm³) during the base operation will be studied in Inventive Example 5. In order to maintain the gas volume in front of the tuyere and make the heat flow ratio at the substantially same level as that in the base operation, the volume of the circulating CO₂ can be increased. When the amount of charged carbon is increased to increase the heat input with the amount of charged ore kept constant, the gas volume in the tuyere-front raceway increases due to the increase in volume of CO₂ and the increase in volume of CO in front of the tuyere caused by the increase in amount of the charged carbon.

Specifically, the heat balance and the tuyere-front raceway temperature Tf when the value of the heat input in Inventive Example 4 (177.5×10³ kcal) is gradually increased by increasing the charged carbon are calculated. When the gas volume is calculated as described below based on a formula (C′), in which the amount of heat input in the above formula (C) is changed to 215×10³ kcal, and the formula (D), the gas volume in the tuyere-front raceway is 121 Nm³.

$$103.3 Y \times 1 {0}^{3} kcal + 14.63 W \times 1 {0}^{3} kcal = 215 \times {10}^{3} kcal \qquad ( {C}^{′} )$$

$$29.98 Y \times 1 {0}^{3} kcal - 51.14 W \times 1 {0}^{3} kcal = 32.16 \times 1 {0}^{3} kcal \qquad ( D )$$

### Carbon Charge Amount Y and N₂ Gas Circulation Amount W

The above formulae (C′) and (D) are solved as equations with two unknowns to calculate the carbon charge amount Y and the CO₂ circulation amount W.
Carbon charge amount Y: 2.004 kmol, which shows 16.0% reduction in CO₂ with respect to 2.386 in the base operation
CO₂ circulation amount W: 0.5460 kmol

### Composition and Volume of Gas in Front of Tuyere

CO: 96.5 Nm³

The breakdown of the calculation is (3×Y−1.7044) kmol (see the breakdown of the calculation in Inventive Example 1). When Y=2.004 kmol is assigned to the above formula, 4.308 kmol=96.5 Nm³ is obtained.
CO generated by the reaction of CO₂ and C: 24.5 Nm³=2×0.5460 kmol

A total gas volume is 121 Nm³.

### Blast Furnace Operation Method Involving Injection of Part of CO₂-Removed CO Gas and Part of Blast Furnace Gas Through Blast Furnace Tuyere

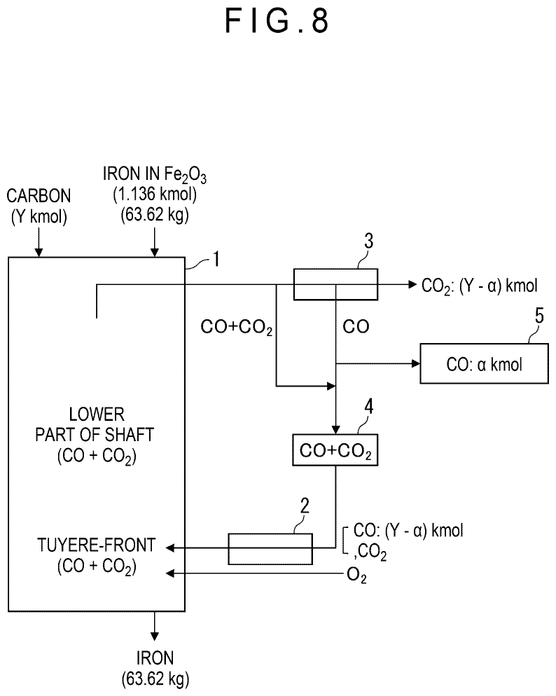

FIG. 8 illustrates a blast furnace operation method involving injection of a part of the CO₂-removed CO gas and a part of the blast furnace gas through the blast furnace tuyere. The significance of the above blast furnace operation method is the same as that of the blast furnace operation involving injection of a part of CO gas and N₂ gas through the tuyere (see the description for the blast furnace operation method illustrated in FIG. 6).

FIG. 8 illustrates a flow of blowing a kmol of CO gas, from which CO₂ gas is removed by the CCS 3, into the blast furnace gas holder 5. A collected amount of CO₂ is (Y−α) kmol subtracting CO blown into the holder.

Blast Furnace Operation Method Involving Injection of CO₂-Removed CO Gas Containing H₂ Gas Through Blast Furnace Tuyere

In the blast furnace operation involving injection through the blast furnace tuyere of the CO₂-removed CO gas together with the rest of the blast furnace gas not separating and removing CO₂ from the blast furnace gas discharged from the blast furnace top, mixing H₂ gas into the CO₂-removed CO gas facilitates the further reduction in the amount of charged carbon and consequently the amount of CO₂.

When all of the CO₂-removed CO gas is injected through the tuyere, the H₂ gas injected through the tuyere is returned to the blast furnace similarly to the CO gas to take oxygen away from the ore, where a hydrogen utilization efficiency ηH₂ is 100%, that is, all of the H₂ gas is used.

### Summary of Injection of Blast Furnace Gas Containing CO₂ Gas Through Tuyere

In injecting the blast furnace gas (CO) through the tuyere, CO₂ gas circulation is as useful as N₂ gas circulation. With the use of CO₂ gas within the blast furnace, unused CO gas within the blast furnace gas can be fully (i.e. by 100%) used, making it possible to reduce the amount of the carbon used in the blast furnace by 16%. When the CO₂-removed CO gas contains H₂ gas, the amount of carbon used is further reducible and further reduction in CO₂ is expectable.

TABLE 2

| | | | Inventive Ex. 4 | | Inventive Ex. 5 | |
|---|---|---|---|---|---|---|
| | Comp. 1 | | CO injection, CO₂ | | CO injection, CO₂ circulation | |
| | Base Operation | | circulation | | Tuyere-Front Gas Volume Being Kept | |
| Case | Air Injection | | Oxygen Injection | | Oxygen Injection | |
| Iron Yield | 63.62 | kg | 63.62 | kg | 63.62 | kg |
| Charged Carbon | 2.386 | kmol | 1.669 | kmol | 2.004 | kmol |
| | 450 | kg/tFe | 315 | kg/tFe | 378 | kg/tFe |
| Circulating CO₂ | — | | 0.349 | kmol | 0.546 | kmol |
| Used Amount of Pure | 0 | | 275 | Nm³/pig | 387 | Nm³/pig |
| Oxygen★ | | | | | | |
| Tuyere-Front Gas | 42 | | 90 | | 121 | |
| CO | | | | | | |
| N₂ | 79 | | — | | — | |
| Total | 121 | Nm³ | 90 | Nm³ | 121 | Nm³ |
| Tuyere-Front Temperature | 2,356° | C.★★ | 2,100° | C. | 2,100° | C. |

| | | | |
|---|---|---|---|
| CO₂ Reduction | Base | 30% | 16% |

★Carbon component in pig iron is assumed to be 4.5%.
★★Theoretically 2,356 degrees C. in all-coke operation. However, due to injection of fine powdered coal, approximately 2,100 degrees C. in an actual operation.

According to the above-described invention, pig iron can be produced with reduced CO₂ under substantially the same operation conditions as those in existing large blast furnaces.

### EXPLANATION OF CODES

1 blast furnace
2 hot-blast stove
3 CCS (carbon dioxide capture and storage)
4 tuyere-injection gas relay tank
5 blast furnace gas holder

1-6. (canceled)

7. A blast furnace operation method comprising:
injecting O₂ gas through a tuyere of a blast furnace in place of air blast;
separating and removing CO₂ from a blast furnace gas discharged from a furnace top of the blast furnace; and
injecting all of CO gas after removing CO₂ through the tuyere of the blast furnace, wherein
all of N₂ gas, which is injected through the tuyere of the blast furnace and discharged from the furnace top of the blast furnace together with the CO gas after removing CO₂, is circulated within the blast furnace to make a N₂ circulation amount in the blast furnace constant.

8. A blast furnace operation method comprising:
injecting O₂ gas through a tuyere of a blast furnace in place of air blast;
separating and removing CO₂ from a blast furnace gas discharged from a furnace top of the blast furnace; and
injecting a part of CO gas after removing CO₂ through the tuyere of the blast furnace, wherein
N₂ gas, which is injected through the tuyere of the blast furnace and discharged from the furnace top of the blast furnace together with the part of the CO gas after removing CO₂, is circulated within the blast furnace to make a N₂ circulation amount in the blast furnace constant.

9. The blast furnace operation method according to claim 7, wherein an H₂ gas is injected through the tuyere of the blast furnace and the CO gas after removing CO₂ comprises the H₂ gas.

10. A blast furnace operation method comprising:
injecting O₂ gas through a tuyere of a blast furnace in place of air blast;
separating and removing CO₂ from a part of a blast furnace gas discharged from a furnace top of the blast furnace to produce a CO gas; and
injecting, through the tuyere of the blast furnace, all of the CO gas after removing CO₂ together with a rest of the blast furnace gas not separating and removing CO₂ from the blast furnace gas discharged from the furnace top of the blast furnace to make a CO₂ circulation amount in the blast furnace constant.

11. A blast furnace operation method comprising:
injecting O₂ gas through a tuyere of a blast furnace in place of air blast;
separating and removing CO₂ from a part of a blast furnace gas discharged from a furnace top of the blast furnace to produce a CO gas; and
injecting, through the tuyere of the blast furnace, a part of the CO gas after removing CO₂ together with a rest of the blast furnace gas not separating and removing CO₂ from the blast furnace gas discharged from the furnace top of the blast furnace to make a CO₂ circulation amount in the blast furnace constant.

12. The blast furnace operation method according to claim 10, wherein an H₂ gas is injected through the tuyere of the blast furnace and the CO gas after removing CO₂ comprises the H₂ gas.

13. The blast furnace operation method according to claim 8, wherein an H₂ gas is injected through the tuyere of the blast furnace and the CO gas after removing CO₂ comprises the H₂ gas.

14. The blast furnace operation method according to claim 11, wherein an H₂ gas is injected through the tuyere of the blast furnace and the CO gas after removing CO₂ comprises the H₂ gas.
